(19) United States
(12) Patent Application Publication
(10) Pub. No.: US 2017/0102124 A1
(43) Pub. Date: Apr. 13, 2017

(54) DISPLAY DEVICE AND REFLECTIVE SHEET THEREOF

(71) Applicant: Wuhan China Star Optoelectronics Technology Co., Ltd, Wuhan, Hubei (CN)

(72) Inventor: Jie Zeng, Wuhan, Hubei (CN)

(73) Assignee: Wuhan China Star Optoelectronics Technology Co., Ltd., Wuhan, Hubei (CN)

(21) Appl. No.: 14/778,216

(22) PCT Filed: Jun. 18, 2015
(86) PCT No.: PCT/CN2015/081851

§ 371 Date: Dec. 1, 2016

(30) Foreign Application Priority Data
May 19, 2015 (CN) 201510257803.X

(51) Int. Cl. F21V 7/22; G02B 5/02; G02B 5/08

(52) U.S. Cl. CPC F21V 7/22; G02B 5/0808; G02B 5/0226; G02B 5/0284; G02B 2207/113

(57) ABSTRACT

A reflective sheet is provided, comprising a base layer, a reflecting layer coated on the base layer, and a scattering layer coated on a side of the reflecting layer that faces away from the base layer. Emergent light from such a reflective sheet is more uniform, whereby quality of an image displayed on a display device using said reflective sheet is improved.

### CROSS REFERENCE TO RELATED APPLICATION

The present application claims benefit of Chinese patent application CN 201510257803.X, entitled “A Display Device and A Reflective Sheet Thereof” and filed on May 19, 2015, the entirety of which is incorporated herein by reference.

### TECHNICAL FIELD

The present disclosure relates to the technical field of display, and in particular to a reflective sheet. The present disclosure further relates to a display device comprising the reflective sheet.

### TECHNICAL BACKGROUND

A reflective sheet is an optical member used to alter light path. The reflective sheet is often used in a display device, so as to alter the path of light from a backlight therein.

A reflective sheet in the prior art usually only reflects light from a backlight as a mirror, rendering light penetrating the reflective sheet non-uniform, whereby it is impossible for a display region of a display device using the reflective sheet to acquire uniform light source. Consequently, image displayed on the display device presents non-uniform brightness, and color of the image would be severely distorted.

Therefore, a reflective sheet with high emergent light uniformity is urgently needed.

### SUMMARY OF THE INVENTION

Directing at the above problem, the present disclosure provides a reflective sheet, which has high emergent light uniformity. The present disclosure further provides a display device comprising said reflective sheet.

According to a first aspect of the present disclosure, a reflective sheet is proposed, comprising a base layer, a reflecting layer coated on the base layer, and a scattering layer coated on a side of the reflecting layer that faces away from the base layer.

When the reflective sheet of the present disclosure is used, light penetrates the scattering layer and is reflected at the reflecting layer, and then passes through the scattering layer and exits from the reflective sheet. Light scatters when passing through the scattering layer, whereby light changes direction and scatters towards multiple directions. In this case, with the above structure, after light exits from the reflective sheet, it covers a larger area, whereby the emergent light uniformity of the reflective sheet can be improved.

In an embodiment according to the present disclosure, the scattering layer comprises a plurality of quantum fluorescent particles provided on the side of the reflecting layer that faces away from the base layer. When irradiated by light, the quantum fluorescent particles are stimulated, thereby emitting light. The light emitted due to the stimulation goes towards all directions, so that the light passes through the scattering layer towards all directions, whereby the emergent light uniformity of the reflective sheet can be improved. In addition, light from the quantum fluorescent particles can stimulate surrounding quantum fluorescent particles to emit light to all directions. Such structure enables light to scatter more uniformly in the scattering layer, whereby the uniformity of light exiting from the reflective sheet can be guaranteed.

In an embodiment according to the present disclosure, the scattering layer comprises a dielectric body arranged on the side of the reflecting layer that faces away from the base layer, and a plurality of quantum fluorescent particles scattered in the dielectric body. The quantum dot fluorescent particles are stimulated to emit light, thereby guaranteeing the uniformity of light exiting from the reflective sheet. In addition, the quantum fluorescent particles can be easily coated on the reflecting layer through the dielectric body, thereby reducing the difficulty of a manufacturing process.

In another embodiment according to the present disclosure, the plurality of quantum fluorescent particles comprises cadmium selenide quantum dot fluorescent particles. Cadmium selenide quantum fluorescent particles have better fluorescent effect and can emit light of high brightness uniformly, whereby the uniformity of light exiting from the reflective sheet can be effectively improved. In addition, cadmium selenide quantum fluorescent particles can emit pure monochromatic light of high quality, so that quality of the emergent light from the reflective sheet can be improved, whereby image quality of a display device using said reflective sheet can be effectively guaranteed.

In an embodiment according to the present disclosure, the plurality of quantum fluorescent particles has different particle sizes. Under the radiation of light from the backlight, the quantum fluorescent particles having different particle sizes can emit respective lights of different colors. Lights passing through the reflective sheet can be mixed into high quality white light by reasonably selecting and mixing quantum fluorescent particles of corresponding sizes in a suitable proportion.

In an embodiment according to the present disclosure, an isolating layer is further disposed between the reflecting layer and the scattering layer. The isolating layer can isolate the reflecting layer from the scattering layer. In this case, the scattering layer, when being disposed, would not scratch the reflecting layer, whereby a reflecting effect of the reflecting layer can be ensured.

In an embodiment according to the present disclosure, a contact surface between the isolating layer and the scattering layer has a larger roughness than that between the reflecting layer and the isolating layer. The scattering layer uses the isolating layer as a base, so that it can be more stably fixed thereon.

In an embodiment according to the present disclosure, the reflective sheet further comprises a protective layer covering a surface of the scattering layer that faces away from the reflecting layer. The protective layer can prevent the scattering layer from being exposed to the outside, thereby protecting structure of the scattering layer from being damaged. In addition, the protective layer covering the scattering layer can also prevent the scattering layer from oxidation, so that the effectiveness of the scattering layer can be ensured, whereby the emergent light uniformity of the entire reflective sheet can be guaranteed.

In an embodiment according to the present disclosure, the reflective sheet is in the form of a flat plate. Flat plate reflective sheet has the advantages of simple manufacturing process and lower production cost.

According to a second aspect of the present disclosure, a display device is provided, comprising the above reflective sheet. Image displayed on the display device using said reflective sheet has the advantages of better clearness, uniform light, bright color, thereby satisfying a user's e requirements for the image.

As compared with the prior art, the present disclosure has the following advantages. Light penetrates the scattering layer and is reflected at the reflecting layer, and then passes through the scattering layer and exits from the reflective sheet. In addition, light scatters when passing through the scattering layer, whereby light changes direction and scatters towards multiple directions. Moreover, after light exits from the reflective sheet, it covers a larger area, whereby the emergent light uniformity of the reflective sheet can be improved.

### BRIEF DESCRIPTION OF THE ACCOMPANYING DRAWINGS

The present disclosure will be described in detail based on the examples in view of the accompanying drawings. In the drawings:

FIG. 1 schematically shows an example of a reflective sheet according to the present disclosure,

FIG. 2 schematically shows another example of the reflective sheet according to the present disclosure, and

FIG. 3 schematically shows an example of a scattering layer according to FIG. 1 or FIG. 2.

In the drawings, same components are indicated with the same reference sign. The drawings are not drawn to actual scale.

### DETAILED DESCRIPTION OF THE EMBODIMENTS

The present disclosure will be described in detail in view of the accompanying drawings.

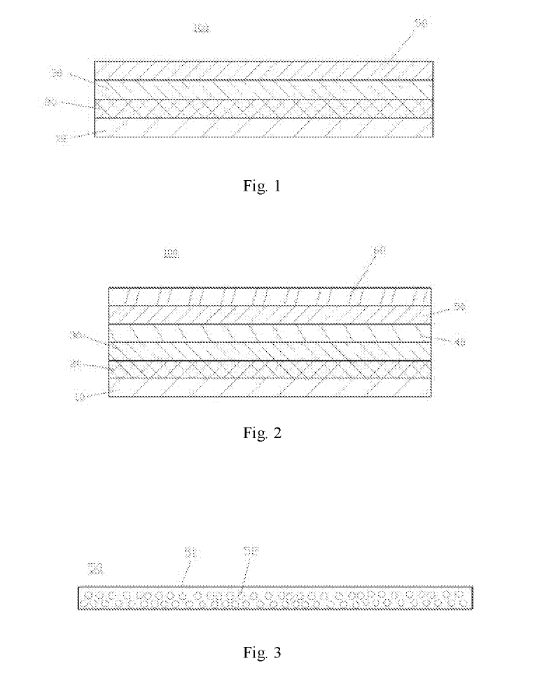

FIGS. 1 and 2 schematically show a general structure of a reflective sheet 100 according to the present disclosure.

The reflective sheet 100 comprises a base layer 10, and a reflecting layer 30 coated on the base layer 10. The reflecting layer 30 can reflect light. Preferably, a bonding layer 20 is disposed between the reflecting layer 30 and the base layer 10, so that the reflecting layer 30 is bonded with the base layer 10, whereby the reflecting layer 30 can be more stably fixed on the base layer 10. The reflective sheet 100 can be used in a display device to reflect light from a backlight arranged therein, so that light can radiate towards desired directions.

The base layer 10 is formed as a structure having certain supporting capacity, which can be made from polyethylene glycol terephthalate (PET).

In order for light from the reflective sheet 100 to be more uniform and not to be limited in given direction and position, a corresponding scattering layer 50 can be further disposed on the reflecting layer 30. The scattering layer 50 can change a direction of light passing therethrough, so that the light can radiate towards more directions, whereby light exiting from the reflective sheet 100 can go towards all directions. As a result, emergent light uniformity of the reflective sheet 100 can be effectively improved.

In an example as shown by FIG. 1, the scattering layer 50 is directly disposed on the reflecting layer 30. Such a structure is simple and costs less.

In an example as shown by FIG. 2, an isolating layer 40 is further disposed between the scattering layer 50 and the reflecting layer 30. In such a structure, the scattering layer 50 is coated on the isolating layer 40 and isolated from the reflecting layer 30, thereby avoiding scratching a surface of the reflecting layer 30. As a result, reflecting effect of the entire reflective sheet 100 can be ensured. The isolating layer 40 can be made from polyethylene glycol terephthalate (PET).

In addition, preferably, an upper surface (i.e., a surface of the isolating layer that is in contact with the scattering layer 50) of the isolating layer 40 has a larger roughness than an upper surface (i.e., a surface of the reflecting layer 30 that is in contact with the isolating layer 40) of the reflecting layer 30. As compared with the case of coating the scattering layer 50 directly on the reflecting layer 30, the scattering layer 50 coated on the isolating layer 40 with a rougher surface does not fall off easily, thereby ensuring a structural stability of the entire reflective sheet 100.

On top of the scattering layer 50, i.e., on a side of the scattering layer 50 that faces away from the reflecting layer 30, a protective layer 60 is coated. The protective layer 60 is coated on the scattering layer 50 to protect it from damage. Preferably, the scattering layer 50 can be sealingly sandwiched between the protective layer 60 and the isolating layer 40, so that oxidation of the scattering layer 50, especially the scattering layer 50 comprising quantum dot fluorescent particles, can be prevented. The protective layer 60 can be made from zinc sulfide (ZnS). It can be understood that in the example shown by FIG. 1, a protective layer 60 can also be disposed accordingly.

The structure of the scattering layer 50 will be described in detail with reference to FIGS. 1 to 3.

In the examples shown by FIGS. 1 and 2, the scattering layer 50 may comprise quantum dot fluorescent particles. In the example shown by FIG. 1, quantum fluorescent particles are directly coated on the reflecting layer 30. In the example shown by FIG. 2, quantum fluorescent particles are directly coated on the isolating layer 40.

Preferably, in the examples shown by FIGS. 1 and 2, the scattering layer 50 comprises a dielectric body 51 and quantum fluorescent particles dispersed in the dielectric body 51, as shown in FIG. 3. In the example shown by FIG. 1, the dielectric body 51 is directly coated on the reflecting layer 30. In the example shown by FIG. 2, the dielectric body 51 is directly coated on the isolating layer 40.

The scattering layer 50 is formed by mixing quantum fluorescent particles 52 with medium fluid, and then coating the resulting mixture on the reflecting layer 30. The medium fluid can be water, alcohol such as methanol and ethanol, esters such as ethyl acelate, halogenated hydrocarbon, or organic solvent such as methylbenzene.

As shown in FIG. 3, the scattering layer 50 can homogenize light passing through the reflective sheet 100 by means of the quantum fluorescent particles 52 dispersed in the entire dielectric body 51. In addition, the manufacturing procedure of such scattering layer 50 is simpler and more readily applied to the production process. In such a scattering layer 50, the quantum fluorescent particles 52 can be uniformly dispersed in the entire dielectric body 51, thereby facilitating uniform emergent light from the reflective sheet 100.

In a working process of the reflective sheet 100, light enters into the scattering layer 50 and radiates the quantum fluorescent particles 52. The quantum fluorescent particles 52 are stimulated and radiate light accordingly. Light from the quantum fluorescent particles 52 goes towards all directions. In this case, light path is changed, and light exiting from the reflective sheet 100 can be more uniform. Furthermore, light emitted by the quantum fluorescent particles 52 under stimulation can also stimulate surrounding quantum fluorescent particles 52 to radiate light, thereby further improving the uniformity of light exiting from the reflective sheet 100. It should be understood that the quantum fluorescent particles 52 are quantum dots, which are semiconductor nanocrystal.

There is a plurality of quantum fluorescent particles 52 in each of the examples shown by FIGS. 1 and 2. The plurality of quantum fluorescent particles 52 can be made of quantum fluorescent particles of the same material, or of quantum fluorescent particles of different materials. The quantum fluorescent particles 52 of mixed materials are easier to use, thereby effectively reducing the difficulty of the manufacturing procedure and the production cost. Material of the quantum fluorescent particles 52 can be selected from a group consisting of CdS, CdSe, CdTe, ZnSe, InP or InAs.

In addition, different quantum fluorescent particles 52 can be selected based on the color of a backlight. The quantum fluorescent particles 52 can be stimulated to radiate light of pure color. In this case, quantum fluorescent particles 52 having corresponding colors with the backlight can be arranged, so that lights can be mixed into white light. As a result, a color gamut of a display device using the reflective sheet 100 can be enlarged, and display quality of the display device can be improved.

Cadmium selenide quantum fluorescent particles can be used to emit high quality monochromatic light with pure color. Furthermore, cadmium selenide quantum fluorescent particles have preferable fluorescent effect, so that they can emit uniform light with high brightness. In addition, color of the emergent light can be selected by choosing a corresponding size of the quantum fluorescent particles 52. For example, cadmium selenide quantum fluorescent particles having 10 nm particle size can be stimulated to radiate high quality pure red light, cadmium selenide quantum fluorescent particles having 2.5 nm particle size can be stimulated to radiate high quality pure green light, and cadmium selenide quantum fluorescent particles having 2 nm particle size can be stimulated to radiate high quality pure blue light.

In an example, the backlight can be blue. In this case, quantum fluorescent particles that can be stimulated to radiate red light and quantum fluorescent particles that can be stimulated to radiate green light can be uniformly mixed and spreaded onto the reflecting layer 30. The red light and the green light can be mixed with blue light from the backlight and form pure white light. Such pure white light can be used in the display device to improve the display effect thereof.

Quantum fluorescent particles that can radiate blue light can also be mixed into those that radiate red light and green light according to requirements, so that lights exiting from the reflective sheet 100 can be mixed into white light more efficiently.

Since light going out of the reflective sheet 100 is already uniform enough with said scattering layer 50, the reflective sheet 100 can be made into a plate, so that the structure thereof can be simplified and the difficulty of the manufacturing procedure and production cost thereof can be reduced.

Said reflective sheet 100 has the advantages of high uniformity of emergent light, and the display device using the reflective sheet 100 has desirable display quality. Image displayed on the display device using said reflective sheet has the advantages of uniform brightness and more genuine and bright color, whereby a user's e requirements for the image can be satisfied.

Although the present disclosure has been described with reference to preferred embodiments, various modifications and variants to the present disclosure may be made by anyone skilled in the art, without departing from the scope and spirit of the present disclosure. In particular, as long as there is no structural conflict, various embodiments as well as the respective technical features mentioned herein may be combined with one another in any manner. The present disclosure is not limited to the specific examples disclosed herein, but rather includes all the technical solutions falling within the scope of the claims.

1. A reflective sheet comprising a base layer, a reflecting layer coated on the base layer, and a scattering layer coated on a side of the reflecting layer that faces away from the base layer.

2. The reflective sheet according to claim 1, wherein an isolating layer is further disposed between the reflecting layer and the scattering layer.

3. The reflective sheet according to claim 2, wherein a contact surface between the isolating layer and the scattering layer has a larger roughness than that between the reflecting layer and the isolating layer.

4. The reflective sheet according to claim 1, wherein the scattering layer comprises a plurality of quantum fluorescent particles coated on the side of the reflecting layer that faces away from the base layer.

5. The reflective sheet according to claim 4, wherein the plurality of quantum fluorescent particles comprises cadmium selenide quantum fluorescent particles.

6. The reflective sheet according to claim 4, wherein the plurality of quantum fluorescent particles has different particle sizes.

7. The reflective sheet according to claim 1, wherein the scattering layer comprises a dielectric body provided on the side of the reflecting layer that faces away from the base layer, and a plurality of quantum fluorescent particles scattered in the dielectric body.

8. The reflective sheet according to claim 7, wherein the plurality of quantum fluorescent particles comprises cadmium selenide quantum fluorescent particles.

9. The reflective sheet according to claim 7, wherein the plurality of quantum fluorescent particles has different particle sizes.

10. The reflective sheet according to claim 7, wherein an isolating layer is further disposed between the reflecting layer and the scattering layer.

11. The reflective sheet according to claim 10, wherein a contact surface between the isolating layer and the scattering layer has a larger roughness than that between the reflecting layer and the isolating layer.

12. The reflective sheet according to claim 1, further comprising a protective layer covering a surface of the scattering layer that faces away from the reflecting layer.

13. The reflective sheet according to claim 1, wherein the reflecting sheet is in the form of a flat plate.

14. A display device, comprising a reflective sheet, wherein the reflective sheet comprises a base layer, a reflecting layer coated on the base layer, and a scattering layer coated on a side of the reflecting layer that faces away from the base layer.

15. The display device according to claim 14, wherein the scattering layer comprises a plurality of quantum fluorescent particles coated on the side of the reflecting layer that faces away from the base layer.

16. The display device according to claim 14, wherein the scattering layer comprises a dielectric body provided on the side of the reflecting layer that faces away from the base layer, and a plurality of quantum fluorescent particles scattered in the dielectric body.

17. The display device according to claim 16, wherein the plurality of quantum fluorescent particles comprises cadmium selenide quantum fluorescent particles.

18. The display device according to claim 16, wherein the plurality of quantum fluorescent particles has different particle sizes.

19. The display device according to claim 14, wherein an isolating layer is further disposed between the reflecting layer and the scattering layer.

20. The display device according to claim 14, further comprising a protective layer covering a surface of the scattering layer that faces away from the reflecting layer.
